(19) United States
(12) Patent Application Publication
(10) Pub. No.: US 2026/0197068 A1
(43) Pub. Date: Jul. 9, 2026

(54) COMMUNICATION METHOD, RELAY APPARATUS, AND NETWORK NODE

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/552,402

(22) Filed: Feb. 27, 2026

Related U.S. Application Data
(63) Continuation of application No. PCT/JP2024/030519, filed on Aug. 27, 2024.

(30) Foreign Application Priority Data
Aug. 31, 2023 (JP) 2023-141204

(51) Int. Cl. H04B 7/06; H04L 5/00

(52) U.S. Cl. CPC H04B 7/06952; H04L 5/0048

(57) ABSTRACT

A communication method using a relay apparatus including a repeater that performs relay transmission of a radio signal between a network node and a user apparatus, and a control terminal used to control the repeater, the communication method including: forming, by the repeater, a plurality of basic beams in different directions; receiving, by the control terminal, a beam change request from the network node, the beam change request for designating two or more basic beams to be combined among the plurality of basic beams and/or a basic beam to be divided among the plurality of basic beams; and performing, by the repeater, combining and/or division of the basic beams designated by the beam change request in response to receiving the beam change request.

### RELATED APPLICATIONS

The present application is a continuation based on PCT Application No. PCT/JP 2024/030519, filed on Aug. 27, 2024, which claims the benefit of Japanese Patent Application No. 2023-141204 filed on Aug. 31, 2023. The content of which is incorporated by reference herein in their entirety.

### TECHNICAL FIELD

The present disclosure relates to a communication method, a relay apparatus, and a network node used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band as opposed to Long Term Evolution (LTE), which is a fourth-generation radio access technology.

Radio signals (radio waves) in a high frequency band such as a millimeter wave band or a terahertz wave band have a high degree of directionality, which poses a problem of reducing the coverage of network nodes (for example, base stations). In order to solve such a problem, a repeater apparatus that is a type of relay apparatuses that performs relay transmission for relaying radio signals between a network node and a user apparatus and can be controlled from a network node is attracting attention (see, for example, Non-Patent Document 1).

Such a repeater apparatus can extend the coverage of the network node while curbing occurrence of interference by, for example, amplifying a radio signal received from a base station and transmitting the radio signal through directional transmission (beamforming). Such a repeater apparatus is referred to as a network-controlled repeater (NCR).

As another example of a relay apparatus that performs relay transmission, a reconfigurable intelligent surface (RIS) apparatus that changes the propagation direction of incident radio waves (radio signals) by reflection or refraction is also being studied. Such an RIS device may also be controllable from the network node.

### CITATION LIST

### Non-Patent Literature

Non-Patent Document 1:3GPP Contribution: RP-213700, “New SI: Study on NR Network-controlled Repeaters”

### SUMMARY

A communication method according to a first aspect is a method using a relay apparatus including a repeater configured to perform relay transmission of a radio signal between a network node and a user apparatus, and a control terminal used to control the repeater. The communication method includes the steps of: forming, by the repeater, a plurality of basic beams in different directions; receiving, by the control terminal, a beam change request from the network node, the beam change request configured to designate two or more basic beams to be combined among the plurality of basic beams and/or a basic beam to be divided among the plurality of basic beams; and performing, by the repeater, combining and/or division of the basic beams designated by the beam change request in response to receiving the beam change request.

A relay apparatus according to a second aspect includes a repeater configured to perform relay transmission of a radio signal between a network node and a user apparatus, and a control terminal used to control the repeater The repeater forms a plurality of basic beams in different directions. The control terminal receives, from the network node, a beam change request configured to designate two or more basic beams to be combined among the plurality of basic beams and/or a basic beam to be divided among the plurality of basic beams. The repeater performs, in response to receiving the beam change request, combining and/or division of the basic beams designated by the beam change request.

A network node according to a third aspect communicates with a relay apparatus including a repeater configured to perform relay transmission of relaying a radio signal transmitted between the network node and a user apparatus, and a control terminal used to control the repeater. The network node includes a transmitter configured to transmit, to the control terminal, a beam change request configured to designate two or more basic beams to be combined among a plurality of basic beams formed in different directions by the repeater and/or a basic beam to be divided among the plurality of basic beams.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an example of an application scenario of an NCR apparatus (relay apparatus) according to a first embodiment.

FIG. 5 is a diagram illustrating an example of an application scenario of the NCR apparatus according to the first embodiment.

FIG. 6 is a diagram illustrating an example of a control method for the NCR apparatus according to the first embodiment.

FIG. 7 is a diagram illustrating a configuration example of a protocol stack in the NCR apparatus according to the first embodiment.

FIG. 8 is a diagram illustrating a configuration example of the NCR apparatus according to the first embodiment.

FIG. 9 is a diagram illustrating a configuration of UE (user equipment) according to the embodiment.

FIG. 10 is a diagram illustrating a configuration example of a gNB (network node) according to the first embodiment.

FIG. 11 is a diagram illustrating an example of an operation scenario according to the first embodiment.

FIG. 12 is a diagram illustrating an example of a basic beam of an NCR apparatus according to the first embodiment.

FIG. 13 is a diagram illustrating an example of an optimized beam of the NCR apparatus according to the first embodiment.

FIG. 14 is a diagram illustrating a basic operation of the NCR apparatus according to the first embodiment.

FIG. 15 is a diagram illustrating a first operation pattern of a mobile communication system according to the first embodiment.

FIG. 16 is a diagram illustrating a second operation pattern of the mobile communication system according to the first embodiment.

FIG. 17 is a diagram illustrating an example of an application scenario of a RIS apparatus (relay apparatus) according to a second embodiment.

FIG. 18 is a diagram illustrating a configuration example of the RIS apparatus according to the second embodiment.

### DESCRIPTION OF EMBODIMENTS

A relay apparatus that performs relay transmission can form a plurality of beams in different directions by beamforming. Here, when a large number of user apparatuses are collectively accommodated by one beam, there is a concern that resource efficiency may decrease. For this reason, it is desired to realize a technique for enabling flexible change of the state of a beam (beam characteristics) formed by the relay apparatus under the control of a network node and improving resource efficiency (that is, system capacity).

Consequently, an object of the present disclosure is to flexibly change the state of a beam formed by a relay apparatus.

According to an embodiment, a mobile communication system is described with reference to the drawings. In the description of the drawings, the same or similar parts are denoted by the same or similar reference signs.

### (1) First Embodiment

A first embodiment will be described. In the first embodiment, a relay apparatus is a repeater apparatus (that is, an NCR apparatus) that can be controlled from a network.

### (1.1) Overview of Mobile Communication System

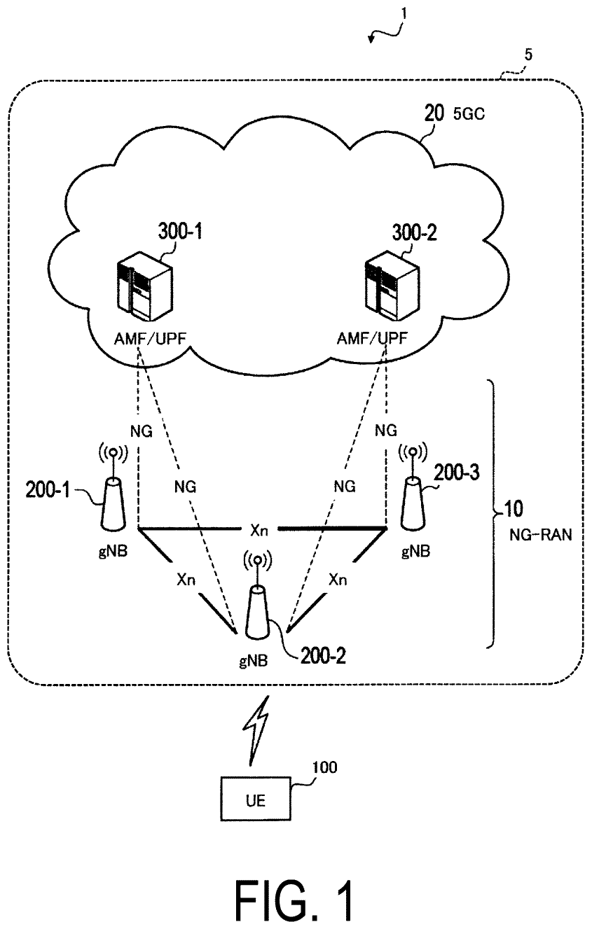

First, an overview of a mobile communication system 1 according to the first embodiment will be described. FIG. 1 is a diagram illustrating a configuration of the mobile communication system according to the first embodiment.

The mobile communication system 1 conforms to the 5th generation system (5GS) of the 3rd generation partnership project (3GPP) (registered trademark; the same applies hereinafter) standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 configure a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (may be a communication card or a chipset), a sensor or an apparatus provided on the sensor, a vehicle or an apparatus (Vehicle UE) provided on the vehicle, and a flying object or an apparatus (Aerial UE) provided on the flying object.

The NG-RAN 10 includes base stations 200 (referred to as “gNBs” or “NG-RAN nodes” in 5G systems), which are a type of network node. The gNBs 200 are connected to each other via an Xn interface, which is an interface between nodes (interface between base stations). Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter, simply referred to as a “frequency”).

The gNB 200 may be functionally divided into a central unit (CU) and a distributed unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to neighboring base stations via an Xn interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5 GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

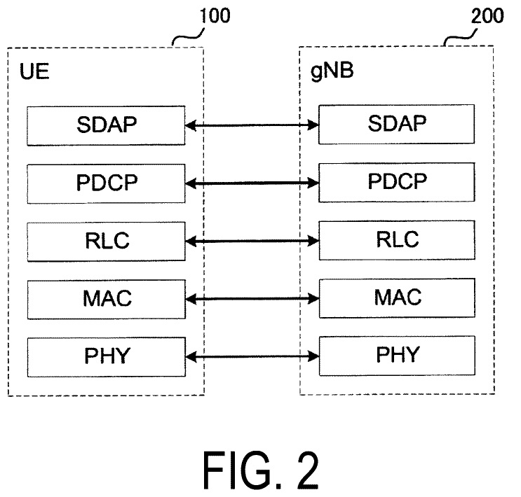

FIG. 2 is a diagram illustrating a configuration of a protocol stack of a wireless interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of PDCCH using a radio network temporary identifier (RNTI) and acquires successfully decoded DCI as DCI addressed to the UE. The DCI transmitted from the gNB 200 has a cyclic redundancy code (CRC) bit scrambled by the RNTI added thereto.

The gNB 200 transmits a synchronization signal block (SSB: Synchronization Signal/PBCH block). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20 RB.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an internet protocol (IP) flow as the unit of quality of service (QoS) control performed by a core network and a radio bearer as the unit of QoS control performed by an access stratum (AS). Note that, when the RAN is connected to the EPC, the SDAP need not be provided.

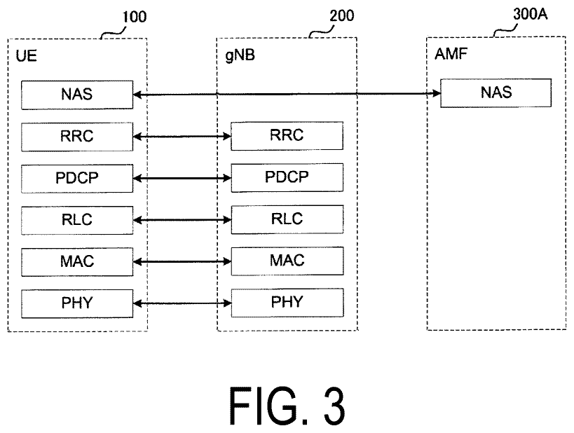

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer, which is located above the RRC layer, performs session management, mobility management, and the like. NAS signaling is transmitted between the NAS layer of the UE 100 and the NAS layer of an AMF 300A. The UE 100 includes an application layer other than the protocol of the radio interface. A layer lower than the NAS layer is referred to as an Access Stratum (AS).

### (1.2) Example of Application Scenario of Relay Apparatus

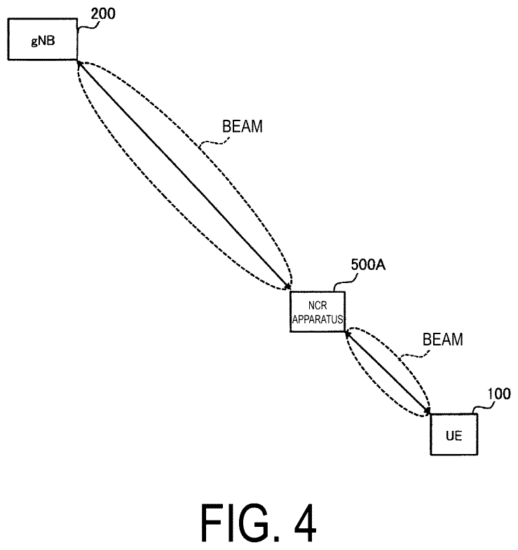

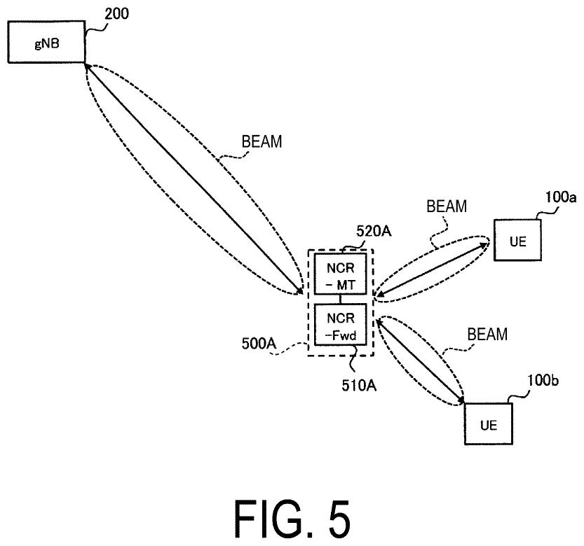

Next, an application scenario of the NCR apparatus (relay apparatus) according to the first embodiment will be described. FIGS. 4 and 5 are diagrams illustrating an example of an application scenario of the NCR apparatus according to the first embodiment. Note that the NCR apparatus may be referred to as an NCR node.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may be in a state of not being able to communicate with the gNB 200 within a line of sight because of obstacles existing between the gNB 200 and the UE 100.

As illustrated in FIG. 4, an NCR apparatus 500A is introduced into the mobile communication system 1, wherein the NCR apparatus 500A is a repeater apparatus (500A) as a type of relay apparatus relaying radio signals between the gNB 200 and the UE 100, and can be controlled from the network 5. Such a repeater apparatus may be called a smart repeater apparatus.

For example, the NCR apparatus 500A amplifies a radio signal (radio wave) received from the gNB 200 and transmits the radio signal through directional transmission. To be specific, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

As illustrated in FIG. 5, a new UE (hereinafter referred to as “NCR-MT (Mobile termination)”) 100B, which is a type of control terminal for controlling the NCR apparatus 500A, is introduced. That is, the NCR apparatus 500A includes an NCR-Fwd (Forwarding) 510A, which is a type of repeater that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A.

Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200. The NCR-MT 520A also has the same and/or similar function as that of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wireless. The NCR-MT 520A may be configured integrally with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed, for example, in a vehicle or the like and may be mobile. One NCR-MT 520A may control the plurality of NCR-Fwds 510A.

The configuration is not limited to a configuration in which the NCR-MT 520A directly controls one or more NCR-Fwds 510A, and may be configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or quasi-statically changes a beam to be transmitted or received. For example, the NCR-Fwd 510A forms a beam toward each of a UE 100 a and a UE 100 b. The NCR-Fwd 510A may also form a beam toward the gNB 200. For example, in a communication resource between the gNB 200 and the UE 100 a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100 b, the NCR-Fwd 510A transmits the radio signal received from the gNB 200 toward the UE 100b through beamforming and/or transmits the radio signal received from the UE 100b toward the gNB 200 through beamforming. Instead of or in addition to the beamforming, the NCR-Fwd 510A may perform null forming (so-called null steering) toward the UE 100 which is not a communication partner (not illustrated) and/or a neighboring gNB 200 (not illustrated) to curb interference.

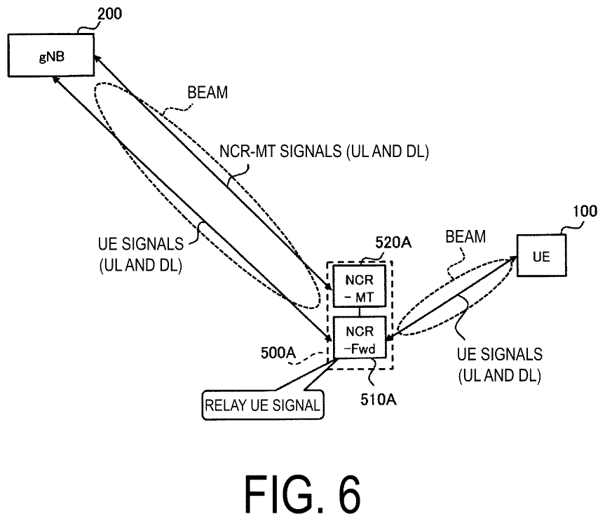

FIG. 6 is a diagram illustrating an example of a control method for the NCR apparatus 500A according to the first embodiment.

The NCR-Fwd 510A relays radio signals (also referred to as “UE signals”) between the gNB 200 and the UE 100. The UE signal includes an uplink signal transmitted from the UE 100 to the gNB 200 (also referred to as “UE-UL signal”) and a downlink signal transmitted from the gNB 200 to the UE 100 (also referred to as “UE-DL signal”). The NCR-Fwd 510A relays the UE-UL signal from the UE 100 to the gNB 200 and relays the UE-DL signal from the gNB 200 to the UE 100. A radio link between the NCR-Fwd 510A and the UE 100 is also referred to as an “access link”. A radio link between the NCR-Fwd 510A and the gNB 200 is also referred to as a “backhaul link”.

The NCR-MT 520A transmits and/or receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A wireless link between the NCR-MT 520A and the gNB 200 is also referred to as a “control link.”

The gNB 200 directs a beam to the NCR-MT 520A based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting and/or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

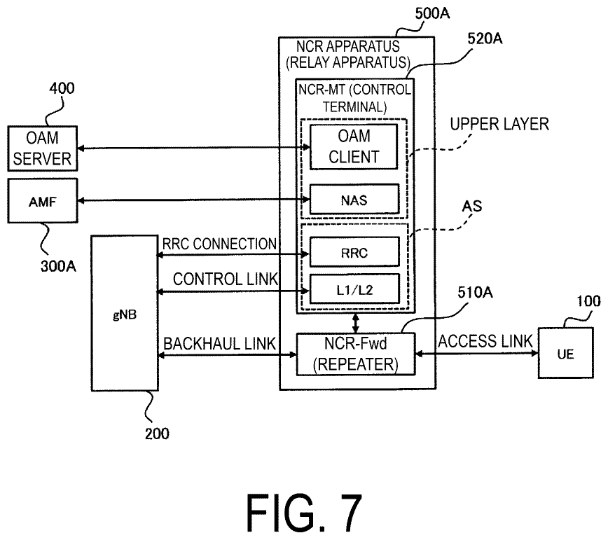

FIG. 7 is a diagram illustrating a configuration example of a protocol stack in the NCR apparatus 500A according to the first embodiment.

The NCR-Fwd 510A relays a radio signal transmitted and/or received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes entities of the layer 1 and/or the layer 2 (L1/L2), and each layer of the RRC and the NAS. The L1/L2 (in particular, PHY, MAC) and the RRC of the NCR-MT 520A are also referred to as “AS of the NCR-MT 520A ”.

The NCR-MT 520A may include at least one selected from the group consisting of an operation, administration, maintenance (OAM) client communicating with an OAM server 400, a NAS layer communicating with the AMF 300A, and an F1 application protocol (AP) layer. The OAM client, the NAS layer, and the F1-AP layer of the NCR-MT 520A are also referred to as “upper layers of the NCR-MT 520A” with reference to the AS of the NCR-MT 520A.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

A control link is established between the gNB 200 and the L1/L2 of the NCR-MT 520A. The L1/L2 of the NCR-MT 520A transmits and/or receives L1/L2 signaling to and from the gNB 200 via the control link. An RRC connection is established between the gNB 200 and the RRC of the NCR-MT 520A. The RRC of the NCR-MT 520A transmits and/or receives an RRC message to and from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC control element (CE), which is a control signal of the MAC layer (that is, layer 2). The NCR control signal may be downlink control information (DCI), which is a control signal of the PHY layer (that is, layer 1). The NCR control signal may be UE-specific signaling. The NCR control signal may be broadcast signaling. The NCR control signal may be a fronthaul message (for example, F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or MAC CE) and used for static or semi-static control of the NCR-Fwd 510A is also referred to as “NCR configuration information” or simply “configuration information”. Such configuration information may be referred to as “side control configuration”. Here, the RRC message may be an RRC reconfiguration message. The NCR configuration information includes, for example, information for configuring ON/OFF of the NCR-Fwd 510A. The NCR configuration information may include, for example, information for semi-static beam configuration of the NCR-Fwd 510A.

On the other hand, the NCR control signal transmitted in the L1/L2 signaling, that is, the DCI (and/or MAC CE) and used for dynamic control of the NCR-Fwd 510A is also referred to as “NCR control information” or simply “control information”. The NCR control information may be referred to as “side control information”. CRC bits of the PDCCH carrying the NCR control information are scrambled by a newly introduced dedicated RNTI. The dedicated RNTI is also referred to as “NCR-RNTI”. The NCR control information may include, for example, information for dynamic beam control of the NCR-Fwd 510A. The NCR configuration information may include information for instructing dynamic On/Off of the NCR-Fwd 510A.

For example, when the NCR-MT 520A is in an RRC connected state, the NCR apparatus 500A can turn on or off the NCR-Fwd 510A according to the NCR control information received from the gNB 200. On the other hand, after the NCR-MT 520A transitions to an RRC inactive state, the NCR apparatus 500A can turn on or off the NCR-Fwd 510A in accordance with the latest (last) configuration information received from the gNB 200.

Further, the NCR control signal (for example, NCR configuration information by RRC and/or NCR control information by L1/L2 signaling) held by the NCR apparatus 500A (NCR-MT 520A) may be referred to as an NCR-Fwd context.

When a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A enters the RRC idle state because a suitable cell cannot be found in the cell selection, the NCR apparatus 500A turns off the NCR-Fwd 510A. The NCR-Fwd 510A is off during an RRC connection re-establishment procedure.

The NCR control signal may include frequency control information designating a center frequency of a radio signal (for example, a component carrier) that is a relay target in the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information designating an operation mode of the NCR-Fwd 510A. The mode control information may be associated with the frequency control information (center frequency). The operation mode may be any one of a mode in which the NCR-Fwd 510A performs non-directional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs omnidirectional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode realized by one directional antenna. The mode may be a beamforming mode realized by applying fixed phase and amplitude control (antenna weight control) to a plurality of antennas. Any of these modes may be designated (set) from the gNB 200 to the NCR-MT 520A. The mode in which the NCR-Fwd 510A performs transmission and/or reception with a variable directional beam may be a mode for performing analog beamforming. The mode may be a mode in which digital beamforming is performed. The mode may be a mode in which hybrid beamforming is performed. The mode may be a mode for forming an adaptive beam specific to the UE 100. Any of these modes may be designated (set) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode for performing single-user (SU) spatial multiplexing. The mode may be a mode for performing Multi-User (MU) spatial multiplexing. The mode may be a mode for performing transmission diversity. Any of these modes may be designated (set) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (set) from the gNB 200 to the NCR-MT 520A in the NCR control signal.

The NCR control signal may include beam control information designating a transmission direction, a transmission weight, or a beam pattern when the NCR-Fwd 510A performs directional transmission. The beam control information may be associated with the frequency control information (center frequency). The beam control information may include a precoding matrix indicator (PMI). The beam control information may include beamforming angle information. When the NCR control signal received from the gNB 200 includes beam control information, the NCR-MT 520A (controller 523) controls the NCR-Fwd 510A to form a transmission directivity (beam) indicated by the beam control information. When the NCR control signal includes the beam control information, the gNB 200 can control the transmission directivity of the NCR apparatus 500A via the NCR-MT 520A.

The NCR control signal may include power control information designating the degree (gain) to which the NCR-Fwd 510A amplifies the radio signal, or transmission power. The power control information may be information indicating a difference value (that is, a relative value) between the current gain or transmission power and a target gain or transmission power. When the NCR control signal received from the gNB 200 includes power control information, the NCR-MT 520A (controller 523) controls the NCR-Fwd 510A so as to perform change to the gain or transmission power indicated by the power control information. The power control information may be associated with frequency control information (center frequency). The power control information may be information designating any one of an amplification gain, a beamforming gain, and an antenna gain of the NCR-Fwd 510A. The power control information may be information designating transmission power of the NCR-Fwd 510A.

When one NCR-MT 520A controls the plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Configuration Example of Each Device

Next, a configuration example of each apparatus in the mobile communication system 1 according to the first embodiment will be described.

### (1.3.1) Configuration Example of Relay apparatus

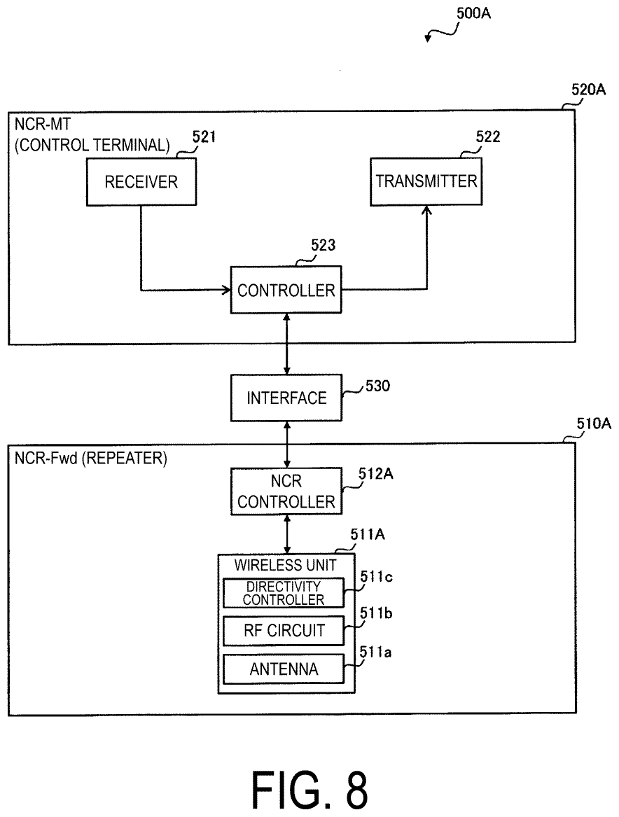

FIG. 8 is a diagram illustrating a configuration example of the NCR apparatus 500A (relay apparatus) according to the first embodiment. The NCR apparatus 500A includes an NCR-Fwd 510A, an NCR-MT 520A, and an interface 530.

The NCR-Fwd 510A includes a wireless unit 511A and an NCR controller 512A. The wireless unit 511A includes an antenna 511a including a plurality of antennas (a plurality of antenna elements), an RF circuit 511b including an amplifier, and a directivity controller 511c that controls directivity of the antenna 511a. The RF circuit 511b amplifies and relays (transmits) radio signals transmitted and/or received by the antenna 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of controls in the NCR-MT 520A. The operation of the NCR-MT 520A (and the NCR apparatus 500A) described above and to be described below may be an operation controlled by the controller 523. The controller 523 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. The controller 523 executes a function of at least one layer selected from the group consisting of the PHY, the MAC, the RRC, and the F1-AP.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In the first embodiment, the receiver 521 of the NCR-MT 520A receives signaling (NCR control signal) used for control of the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Example of Configuration of User Equipment

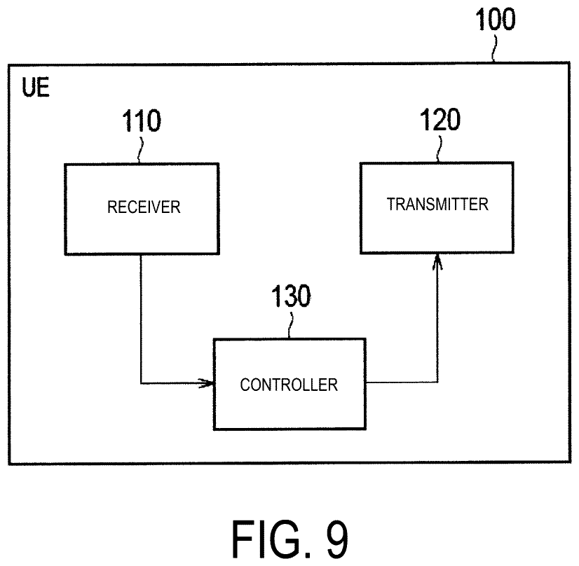

FIG. 9 is a diagram illustrating the configuration of the UE 100 (user apparatus) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The operations of the UE 100 described above and to be described below may also be an operation under the control of the controller 130. The controller 130 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

### (1.3.3) Configuration Example of Network Node

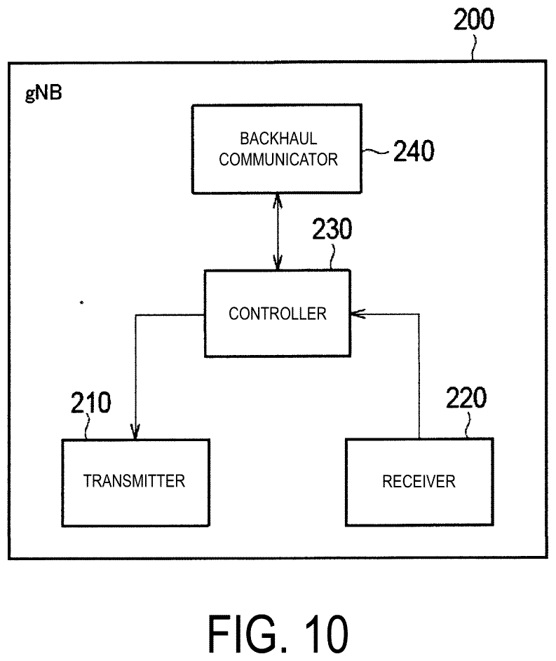

FIG. 10 is a diagram illustrating a configuration example of a gNB 200 (network node) according to the first embodiment. The gNB 200 includes a transmitter 210, a receiver 220, a controller 230, and a backhaul communicator 240.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna. The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230. The transmitter 210 and the receiver 220 may be capable of beamforming using a plurality of antennas.

The controller 230 performs various types of control for the gNB 200. The operations of the gNB 200 described above and below may be also performed under the control of the controller 230. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. The gNB may include a Central Unit (CU) and a Distributed Unit (DU) (that is, functions are divided), and both units may be connected via an F1 interface.

In the first embodiment, the transmitter 210 of the gNB 200 transmits signaling (NCR control signal) used for control of the NCR-Fwd 510A to the NCR-MT 520A through wireless communication. This enables the gNB 200 to control the NCR apparatus 500A via the NCR-MT 520A.

### (1.4) Operation of Mobile Communication System

Next, an operation of the mobile communication system 1 according to the first embodiment will be described.

### (1.4.1) Example of Operation Scenario

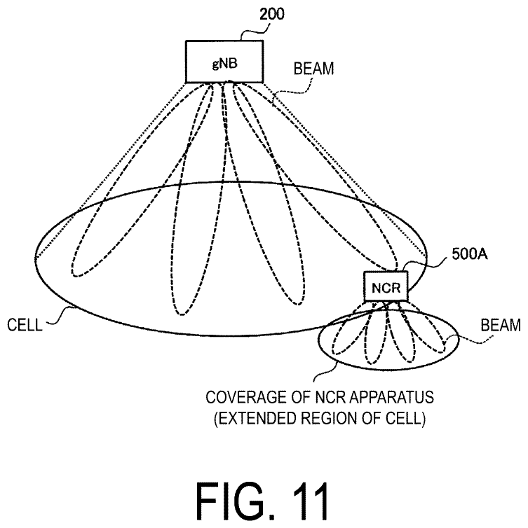

FIG. 11 is a diagram illustrating an example of an operation scenario according to the first embodiment.

In the illustrated example, the NCR apparatus 500A is installed at the end of the cell of the gNB 200. The NCR apparatus 500A is a RAN node including the NCR-Fwd 510A and the NCR-MT 520A. The NCR-Fwd 510A performs relay transmission between the gNB 200 and the UE 100, specifically, amplification and forwarding of UL/DL RF signals. The operation of the NCR-Fwd 510A is controlled in accordance with the side control information (control signal/NCR control signal) received from the gNB 200 by the NCR-MT 520A. The NCR-MT 520A communicates with the gNB 200 via a control link to receive side control information. The control link is based on the NR Uu interface.

The gNB 200 can form a plurality of beams by beamforming. The gNB 200 covers the coverage of its own cell with a plurality of beams. The gNB 200 may transmit a different SSB for each beam. The different SSBs may mean SSBs having different reference signal sequences. The gNB 200 may transmit different SSBs into its own cell while switching beams. The UE 100 that has received the SSB may perform physical random access channel (PRACH) transmission in a random access resource associated with the received SSB (beam) at the time of initial access. Any beam of the gNB 200 may be directed to the NCR apparatus 500A. The gNB 200 may transmit different SSBs with a beam directed to the NCR apparatus 500A in a time division manner. The NCR apparatus 500A (NCR-Fwd 510A) may perform relay transmission of the SSB received from the gNB 200.

The NCR apparatus 500A (NCR-Fwd 510A) can form a plurality of beams by beamforming. The NCR apparatus 500A (NCR-Fwd 510A) can extend the coverage of the cell of the gNB 200 by covering its own coverage with a plurality of beams. That is, the coverage of the NCR apparatus 500A (NCR-Fwd 510A) configures an extended region of the cell of the gNB 200. The NCR apparatus 500A (NCR-Fwd 510A) may be able to form a beam with any width in any direction. The NCR apparatus 500A (NCR-Fwd 510A) may be able to cover an area in all directions (360°) by transmitting beams having the same width at the same angular intervals as a basic configuration. Hereinafter, a beam with such a configuration will also be referred to as a “basic beam”. The configuration of the basic beam may be preset in the NCR apparatus 500A. The configuration may be performed on the NCR apparatus 500A by the gNB 200.

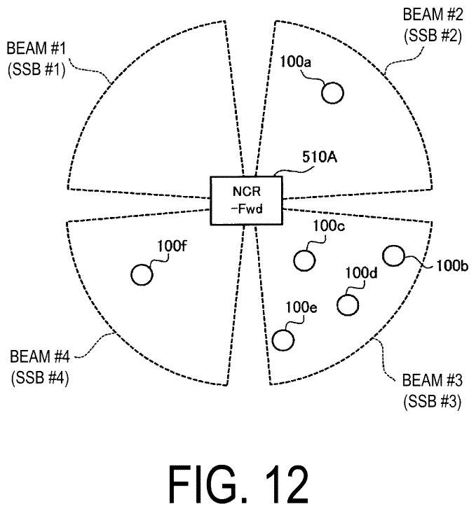

FIG. 12 is a diagram illustrating an example of a basic beam of the NCR apparatus 500A according to the first embodiment. In the illustrated example, the NCR apparatus 500A (NCR-Fwd 510A) forms four beams having a width of 90° as basic beams. The NCR apparatus 500A (NCR-Fwd 510A) may relay different SSBs for each beam. The gNB 200 may relay different SSBs while switching beams. For example, the NCR apparatus 500A (NCR-Fwd 510A) relays the following SSBs at different timings (slots).
Beam #1: SSB #1
Beam #2: SSB #2
Beam #3: SSB #3
Beam #4: SSB #4.

Note that the number indicated by “#” may represent an identifier (index).

In the example of FIG. 12, the number of UEs 100 accommodated by the basic beam #1 is zero. The number of UEs 100 accommodated by the basic beam #2 is one (UE 100a). The number of UEs 100 accommodated by the basic beam #3 is four (UE 100b to UE 100e). The number of UEs 100 accommodated by the basic beam #4 is one (UE 100f). In this example, the number of UEs 100 (traffic amount) accommodated by the basic beam #3 is larger than those of the other beams. For this reason, the probability of PRACH collision between the UEs 100 accommodated by the basic beam #3 may increase.

The gNB 200 may perform statistical analysis for, such as UE distribution (traffic density) for each basic beam, by communicating with the UE 100 via the NCR apparatus 500A, and determine an optimal beam direction and/or width of the NCR apparatus 500A. The gNB 200 transmits a request (configuration) for applying the determined beam to the NCR apparatus 500A (NCR-MT 520A).

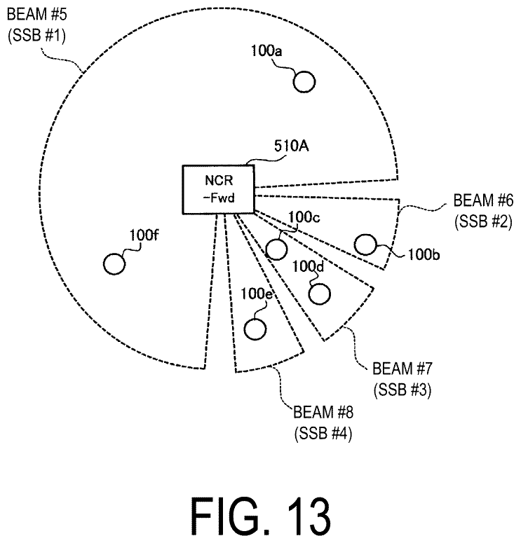

FIG. 13 is a diagram illustrating an example of an optimized beam of the NCR apparatus 500A according to the first embodiment. In the illustrated example, the NCR apparatus 500A (NCR-Fwd 510A) forms a new beam #5 having a width of 270° in which the basic beam #1, the basic beam #2, and the basic beam #4 are combined. In addition, the NCR apparatus 500A (NCR-Fwd 510A) also divides the basic beam #3 to form three new beams #6 to #8 each having, for example, a width of 30°. The NCR apparatus 500A (NCR-Fwd 510A) may relay a different SSB for each new beam. The gNB 200 may relay different SSBs while switching new beams. For example, the NCR apparatus 500A (NCR-Fwd 510A) relays the following SSBs at different timings (slots).
Beam #5: SSB #1
Beam #6: SSB #2
Beam #7: SSB #3
Beam #8: SSB #4.

In the example of FIG. 13, the number of UEs 100 accommodated by the new beam #5 are two (UE 100a and UE 100f). The number of UEs 100 accommodated by the new beam #6 is one (UE 100b). The number of UEs 100 accommodated by the new beam #7 is two (UE 100c and UE 100d). The number of UEs 100 accommodated by the new beam #8 is one (UE 100e).

Thereby, even though the same four beams are used, traffic for each beam is leveled, resource efficiency is increased, and system capacity is improved. In particular, the density (traffic density) of the UEs 100 of each beam is leveled, and a PRACH collision probability is also reduced. In addition, since the number of UEs in the same SSB direction is leveled also for physical downlink shared channel (PDSCH) transmission, the throughput for each UE 100 tends to be fair.

In this manner, in the first embodiment, it is possible to flexibly change the state (beam characteristics) of a beam formed by the NCR apparatus 500A (NCR-Fwd 510A) under the control of the gNB 200, and the resource efficiency (that is, system capacity) is improved.

### (1.4.2) Basic Operation

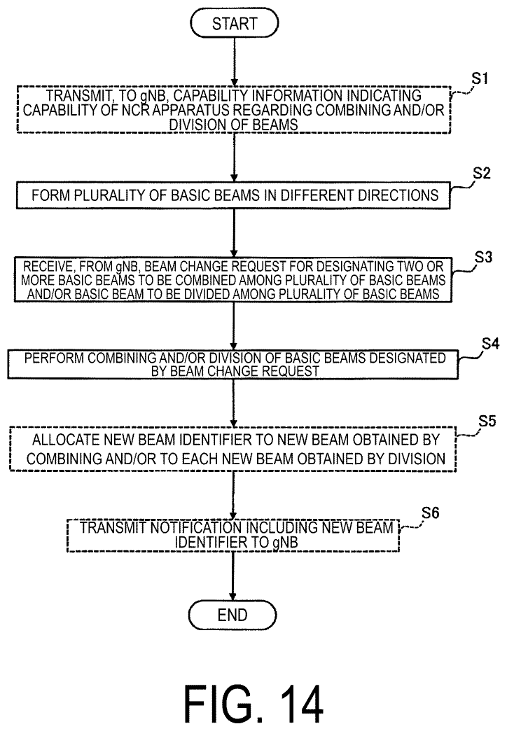

FIG. 14 is a diagram illustrating a basic operation of the NCR apparatus 500A according to the first embodiment.

In step S1, the NCR apparatus 500A (NCR-MT 520A) may transmit capability information (also referred to as “beam capability information”) indicating the capability of the NCR apparatus 500A (NCR-Fwd 510A) regarding the combining (also referred to as “aggregation”) of beams and/or the division (also referred to as “separation”) of beams to the gNB 200 over a control link. The NCR apparatus 500A (NCR-MT 520A) may include a UE Capability Information message, which is a type of RRC message, in the beam capability information, and transmit the UE Capability Information message including the beam capability information to the gNB 200. The NCR apparatus 500A (NCR-MT 520A) may transmit the UE Capability Information message to the gNB 200 in response to receiving a UE Capability Enquiry message, which is a type of RRC message, from the gNB 200.

The beam capability information may include at least one of the following pieces of information:
Information indicating a combination of basic beams required to cover a coverage area of the NCR apparatus 500A;
Information indicating the number of possible divisions of each of a plurality of basic beams;
For each of the plurality of basic beams, each beam identifier of a preset divided beam; and
For each of the plurality of basic beams, beam identifiers of other basic beams that can be combined with the basic beam.

Note that the NCR apparatus 500A (NCR-MT 520A) does not need to transmit its own beam capability information to the gNB 200. The gNB 200 may acquire beam capability information of the NCR apparatus 500A (NCR-Fwd 510A) from an OAM (for example, the OAM server 400).

In step S2, the NCR apparatus 500A (NCR-MT 520A) forms a plurality of basic beams in different directions. It is assumed that a beam identifier is allocated to each of the plurality of basic beams. The NCR apparatus 500A (NCR-Fwd 510A) may cover an area in all directions (360°) by transmitting the basic beams at the same angular intervals. Alternatively, the NCR apparatus 500A (NCR-Fwd 510A) may cover an area in a partial range (for example, 180°), not an area in all directions (360°), by transmitting the basic beams at the same angular interval. Note that the order of steps S1 and S2 may be reversed.

In step S3, the NCR apparatus 500A (NCR-MT 520A) receives a beam change request from the gNB 200 on a control link, the beam change request for designating two or more basic beams to be combined among the plurality of basic beams and/or a basic beam to be divided among the plurality of basic beams. The beam change request includes each beam identifier of the two or more basic beams to be combined and/or a beam identifier of the basic beam to be divided. The NCR apparatus 500A (NCR-MT 520A) may receive an RRC message (for example, an RRC Reconfiguration message) including the beam change request, a MAC CE including the beam change request, or DCI including the beam change request from the gNB 200.

In step S4, the NCR apparatus 500A (NCR-Fwd 510A) performs, in response to the reception of the beam change request in step S3, combining and/or division of the basic beams designated by the beam change request.

In step S5, the NCR apparatus 500A (NCR-MT 520A) may allocate new beam identifiers to new beams obtained by combining the basic beams and/or to each new beam obtained by dividing the basic beam.

In step S6, the NCR apparatus 500A (NCR-MT 520A) transmits, to the gNB 200, a notification (“beam change notification”) including the new beam identifiers allocated in step S5. The NCR apparatus 500A (NCR-MT 520A) may transmit, to the gNB 200, an RRC message (for example, an RRC Reconfiguration Complete message or a UE Assistance Information message) including the beam change notification, a MAC CE including the beam change notification, or uplink control information (UCI) including the beam change notification.

The beam change notification may include at least one of the following pieces of information:
Information indicating a correspondence relationship between each of beam identifiers of two or more basic beams combined and a beam identifier of a new beam obtained by the combining; and
Information indicating a correspondence relationship between a beam identifier of a divided basic beam and a beam identifier of each new beam obtained by the division.

Note that the NCR apparatus 500A may repeatedly execute an operation flow as illustrated in FIG. 14. For example, the NCR apparatus 500A may perform an (n+1)-th operation flow using beams obtained by aggregation and/or separation in an n-th operation flow as new basic beams.

The NCR apparatus 500A that performs the operation as illustrated in FIG. 14 includes the NCR-Fwd 510A that forms a plurality of basic beams in different directions, and the NCR-MT 520A that receives, from the gNB 200, a beam change request for designating two or more basic beams to be combined among the plurality of basic beams and/or a basic beam to be divided among the plurality of basic beams. In response to receiving the beam change request, the NCR-Fwd 510A performs combining and/or division of the basic beams designated by the beam change request. Meanwhile, the gNB 200 includes the transmitter 210 that transmits, to the NCR-MT 520A , a beam change request for designating two or more basic beams to be combined among the plurality of basic beams formed in different directions by the NCR-Fwd 510A and/or a basic beam to be divided among the plurality of basic beams.

### (1.4.3) Specific Example of Operation

As a specific example of the operation of the mobile communication system 1 according to the first embodiment, a first operation pattern and a second operation pattern will be described. For these operation patterns, the operation patterns may be implemented separately and independently. For these operation patterns, two or more operation patterns may be implemented in combination.

### (1.4.3.1) First Operation Pattern

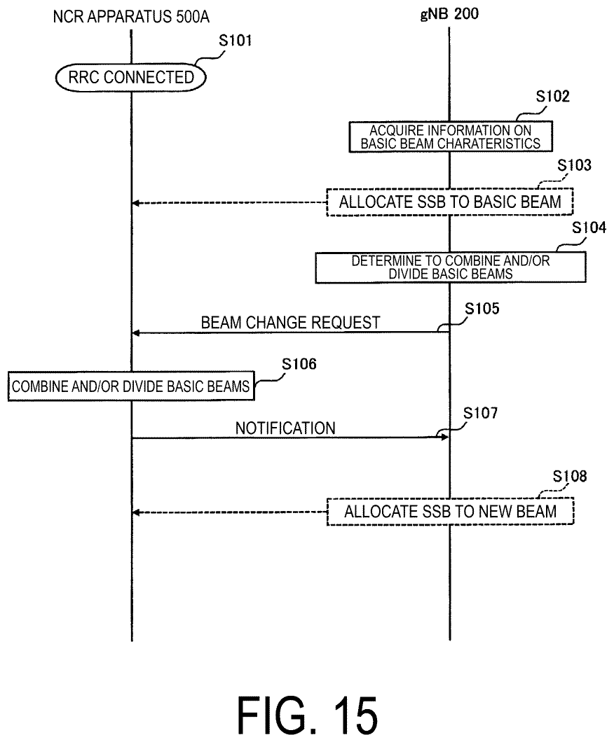

FIG. 15 is a diagram illustrating the first operation pattern of the mobile communication system 1 according to the first embodiment. In the first operation pattern, the gNB 200 instructs the NCR apparatus 500A (NCR-MT 520A) to perform aggregation and/or separation of beams. The NCR apparatus 500A (NCR-MT 520A) allocates new beam identifiers to the aggregated/separated beams and notifies the gNB 200 of the beam identifiers. Note that the beam identifier is an identifier for identifying each beam. The beam identifier may be a beam index or a TCI state ID used in Side Control Information (MAC CE).

In step S101, the NCR apparatus 500A (NCR-MT 520A) is in an RRC connected state in the cell of the gNB 200.

In step S102, the gNB 200 acquires information of basic beam characteristics of the NCR apparatus 500A (NCR-Fwd 510A) from the OAM. For example, the gNB 200 may acquire, from the OAM, information indicating a configuration in which four beams cover 360° {basic beam #1, basic beam #2, basic beam #3, basic beam #4}. Note that these four beams may have a width of 90° or may have a non-uniform beam width. The gNB 200 may not ascertain the details of each basic beam. For example, the gNB 200 does not need to ascertain detailed information such as which basic beam (beam ID) has what degrees of direction and what degrees of width.

In step S103, the gNB 200 may allocate different SSBs to a plurality of basic beams of the NCR apparatus 500A (NCR-Fwd 510A). For example, the gNB 200 allocates the basic beams as {basic beam #1, SSB #1}, {basic beam #2, SSB #2}, {basic beam #3, SSB #3}, and {basic beam #4, SSB #4}. The gNB 200 may transmit information (configuration information) indicating the allocation to the NCR apparatus 500A (NCR-MT 520A).

In step S104, the gNB 200 determines aggregation and/or separation of the basic beams of the NCR apparatus 500A (NCR-Fwd 510A). For example, the gNB 200 may determine to optimize the basic beams, based on the number of UEs 100 with which the gNB 200 communicates via the NCR apparatus 500A (NCR-Fwd 510A), and/or a traffic amount. For example, the gNB 200 ascertains that the traffic amount of each of the beam #1, the beam #2, and the beam #3 is small, and the traffic amount of the beam #4 is large (that is, congested). In this case, the gNB 200 determines to aggregate the beam #1, the beam #2, and the beam #3, and determines to separate the beam #4.

In step S105, the gNB 200 transmits a beam change request (beam adjustment request) to the NCR apparatus 500A (NCR-MT 520A). The NCR apparatus 500A (NCR-MT 520A) receives the beam change request. The beam change request includes at least one of the following pieces of information 1) and 2).

1) Information indicating a set of beam identifiers of basic beams to be aggregated:
For example, the information includes beam identifiers (#1, #2, #3) of the respective basic beams in order to bundle the basic beam #1, the basic beam #2, and the basic beam #3.

2) Information indicating beam identifiers and the number of divisions of basic beams to be separated:
For example, the information includes information such as the beam identifier (#4) of the basic beam and the number of divisions “3” in order to divide the basic beam #4 into three parts.

In step S106, the NCR apparatus 500A (NCR-MT 520A) performs aggregation and/or separation of the basic beams designated by the beam change request in step S105.

For example, when the aggregation of the basic beam #1, the basic beam #2, and the basic beam #3 is designated by the beam change request and the request is received, the NCR apparatus 500A (NCR-MT 520A) calculates beam characteristics that allow these three beams to be covered by one new beam, and allocates a new beam identifier (for example, the beam #5) to the beam characteristics. Note that a beam width of the new beam may be equal to or larger than the sum of the original three beam widths (for example, 90°×3 =270°). However, the NCR apparatus 500A (NCR-MT 520A) may determine that the request is not received. For example, the NCR apparatus 500A (NCR-MT 520A) determines that the request is not received when three beams designated to be aggregated are not adjacent to each other and thus are not bundled.

For example, when the division of the basic beam #4 into three parts is designated by the beam change request, and the NCR apparatus 500A (NCR-MT 520A) receives the request, the NCR apparatus 500A calculates beam characteristics that allow the basic beam #4 to be covered by three beams, and allocates beam identifiers (for example, a beam #6, a beam #7, and a beam #8) of new beams to the beam characteristics. Note that each of the new beams may have a beam width obtained by equally dividing the original beam width (for example, 90°÷3=30°), or may have a non-uniform beam width. However, the NCR apparatus 500A (NCR-MT 520A) may determine that the request is not received. For example, the NCR apparatus 500A (NCR-MT 520A) determines that the request is not received when the NCR apparatus 500A has no ability to generate a fine beam having a width of 90° or less.

In step S107, the NCR apparatus 500A (NCR-MT 520A) transmits, to the gNB 200 on the control link, a notification (beam change notification) indicating the result of the aggregation and/or separation in step S106. The gNB 200 receives the beam change notification. Here, the NCR apparatus 500A (NCR-MT 520A) notifies the gNB 200 of the beam identifiers newly allocated in step S106.

The beam change notification may include association information between the new beam identifier and the original beam identifier. For example, the information may include aggregation information indicating that the aggregation of {beam #1, beam #2, beam #3} is the beam #5. The information may include separation information indicating that the separation of the beam #4 is {beam #6, beam #7, beam #8}.

The notification in step S107 may include information indicating that the request in step S105 has not been received. The information may be, for example, information indicating that aggregation of {beam #1, beam #2, beam #3} is not possible and/or that separation of the beam #4 is not possible.

In step S108, the gNB 200 may allocate SSBs to the new beam identifiers of which the gNB 200 is notified in step S107. For example, the gNB 200 may perform allocation such as {beam #5, SSB #1}, {beam #6, SSB #2}, {beam #7, SSB #3}, and {beam #8, SSB #4}. The gNB 200 may transmit information indicating the allocation to the NCR apparatus 500A (NCR-MT 520A). However, the NCR apparatus 500A (NCR-Fwd 510A) performs PDSCH relay, PUSCH relay, and the like in addition to SSB relay, and thus is not limited to the operation of allocating the SSB. Note that the gNB 200 may transmit information (aperiodic beam indication) indicating an aperiodic beam configuration to the NCR apparatus 500A (NCR-MT 520A). The information (aperiodic beam indication) may include a beam identifier of a beam selected by the gNB 200 from among the basic beams and the new beams.

According to such an operation, it is possible to operate the NCR apparatus 500A (NCR-Fwd 510A) with an optimized beam, and the system capacity can be improved.

### (1.4.3.2) Second Operation Pattern

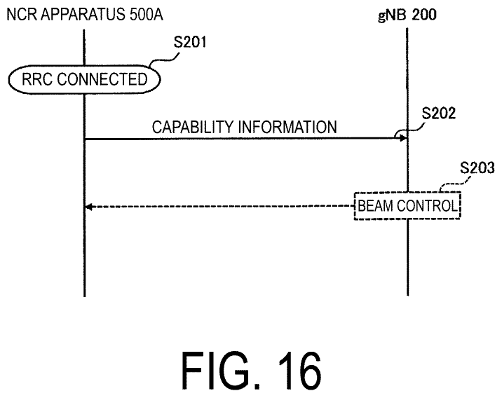

FIG. 16 is a diagram illustrating the second operation pattern of the mobile communication system 1 according to the first embodiment. In the second operation pattern, the NCR apparatus 500A (NCR-MT 520A) notifies the gNB 200 of capability information (beam capability information) of beam aggregation/separation of the NCR-Fwd 510A . Thereby, the gNB 200 can ascertain the beam characteristics of the NCR-Fwd 510A based on the beam capability information without depending on the OAM.

In step S201, the NCR apparatus 500A (NCR-MT 520A) is in an RRC connected state in the cell of the gNB 200.

In step S202, the NCR apparatus 500A (NCR-MT 520A) transmits beam aggregation/separation capability information (beam capability information) of the NCR-Fwd 510A to the gNB 200. The gNB 200 receives the beam capability information.

The beam capability information includes at least one of the following pieces of information 1) to 4).

1) Information indicating a basic beam required to cover a coverage area of the NCR apparatus 500A:
The information may include information indicating a basic beam for covering a range of 360° (for example, a range of 360° can be covered by using the beams #1 to #4). Alternatively, the information may be information indicating a basic beam for covering the maximum area width, instead of 360°.

2) Information indicating the number of possible divisions of each basic beam:
The information may be information indicating the maximum number of possible divisions for each basic beam. Specifically, the number of possible divisions may be the number of divisions (separations) that can be dynamically performed in the first operation pattern.

3) Each beam identifier of a preset divided beam of each basic beam:
For example, the information may be information indicating that three divided beams {beam #6, beam #7, beam #8} are preset for the basic beam #1. In this case, it is indicated that the beam #1 is divided into three parts in advance. This is not a premise for dynamically performing aggregation/separation as in the first operation pattern, but indicates association (hierarchical structure) between beams.

4) For each basic beam, beam identifiers of other basic beams that can be aggregated with the basic beam:
For example, the information may be information indicating that aggregation of the basic beam #1 with other basic beams {beam #2, beam #3, beam #4} is possible. In this case, it is indicated that the beam #1 and the beam #2 can be aggregated with each other, the beam #1 and the beam #3 can be aggregated with each other, and the beam #1 and the beam #4 can be aggregated with each other.

For example, the beam capability information regarding the basic beam #1 may be a data structure such as:
Basic beam flag =True
Preset divided beams {beam #6, beam #7, beam #8}
The number of possible divisions=8
Other basic beams {beam #2, beam #3, beam #4} that can be aggregated. The same and/or similar data structure may be used for other basic beams.

In step S203, the gNB 200 may allocate an SSB to each beam (each basic beam) indicated by the beam capability information in step S202. The gNB 200 may request the NCR apparatus 500A (NCR-MT 520A) to perform aggregation/separation of a certain beam, as in the first operation pattern. The gNB 200 may transmit information (aperiodic beam indication) indicating an aperiodic beam configuration to the NCR apparatus 500A (NCR-MT 520A). The information (aperiodic beam indication) may include a beam identifier of a beam selected by the gNB 200 from among the basic beams and the new beams.

### (2) Second Embodiment

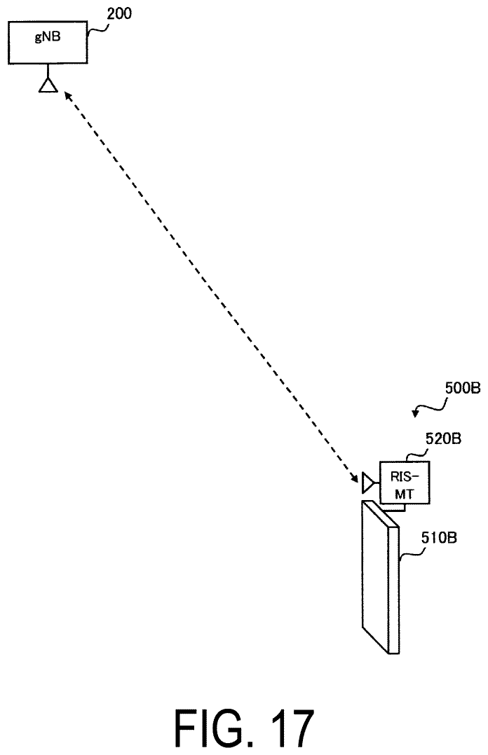

Next, a second embodiment is described mainly focusing on differences from the above-described embodiment. As illustrated in FIG. 17, a relay apparatus according to the second embodiment is a reconfigurable intelligent surface (RIS) apparatus 500B that performs relay transmission for changing the propagation direction of incident radio waves (radio signals) by reflection or refraction. The “NCR” in the above-described embodiment may be read as the “RIS”.

The RIS is a type of repeater (hereinafter, also referred to as a “RIS-Fwd”) capable of performing beamforming (directivity control) in the same and/or similar way to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects an incident radio wave to change a propagation direction of the radio wave. Here, a reflection angle of the radio wave can be variably set. The RIS-Fwd 510B reflects radio waves incident from the gNB 200 toward the UE 100. The RIS-Fwd 510B may be a transmissive RIS. Such an RIS-Fwd 510B refracts an incident radio wave to change the propagation direction of the radio wave. Here, a refraction angle of the radio wave can be variably set.

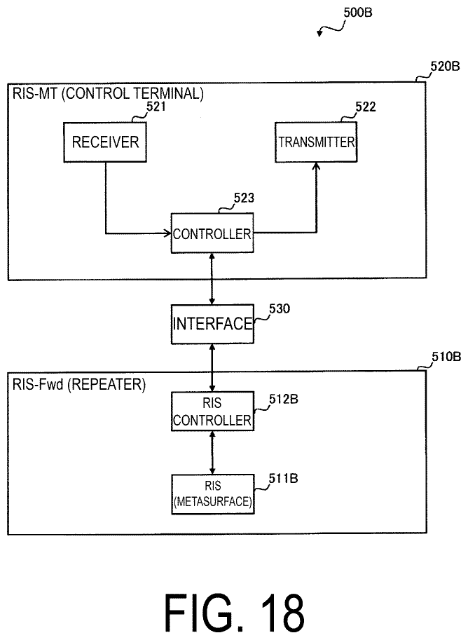

FIG. 18 is a diagram illustrating examples of configurations of the RIS-Fwd (repeater) 510B and the RIS-MT (control terminal) 520B according to the second embodiment. The RIS-MT 520B has a receiver 521, a transmitter 522, and a controller 523. Such a configuration is the same as and/or similar to that of the above-described embodiment. The RIS-Fwd 510B includes a RIS 511B and a RIS controller 512B. The RIS 511B is a metasurface configured using a metamaterial. For example, RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to a RIS control signal from the controller 523 in the RIS-MT 520B. The RIS controller 512B may include at least one processor and at least one actuator. The processor interprets a RIS control signal from the controller 523 in the RIS-MT 520B to drive the actuator in response to the RIS control signal.

### (3) Another Embodiment

In the above-described embodiment, an example in which the relay apparatus performing relay transmission is the NCR apparatus 500A or a RIS apparatus 500B has been described. However, the relay apparatus that performs relay transmission is not limited to the NCR apparatus 500A or the RIS apparatus 500B, and may be an integrated access and backhaul (IAB) node defined in the technical specifications of 3GPP.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an IAB node. The base station may be a distributed unit (DU) of the IAB node. The UE 100 may be a Mobile Termination (MT) of the IAB node.

That is, the UE 100 may be a terminal function unit (a type of communication module) for a base station to control a repeater that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processes performed by the communication apparatus according to the embodiment described above, for example, the UE 100 (NCR-MT 520A and RIS-MT 520B) or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions achieved by the UE 100 or the gNB 200 (the network node) may be implemented in a circuitry or a processing circuitry programmed to perform the described functions, including a general-purpose processor, a special-purpose processor, an integrated circuit, application specific integrated circuits (ASICs), a central processing unit (CPU), a conventional circuit, and/or combinations thereof. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include,” “comprise” and variations thereof do not mean “include only items stated” but instead mean “may include only items stated” or “may include not only the items stated but also other items.” The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variation can be made without departing from the gist of the present disclosure.

### (4) Supplementary Notes

Features relating to the embodiments described above are described below as supplementary notes.

### Supplementary Note 1

A communication method using a relay apparatus including a repeater configured to perform relay transmission of a radio signal between a network node and a user apparatus, and a control terminal used to control the repeater, the communication method including the steps of:
forming, by the repeater, a plurality of basic beams in different directions;
receiving, by the control terminal, a beam change request from the network node, the beam change request configured to designate two or more basic beams to be combined among the plurality of basic beams and/or a basic beam to be divided among the plurality of basic beams; and
performing, by the repeater, combining and/or division of the basic beams designated by the beam change request in response to receiving the beam change request.

### Supplementary Note 2

The communication method according to Supplementary Note 1, in which
a beam identifier configured to identify a basic beam is allocated to each of the plurality of basic beams; and
the beam change request includes beam identifiers of the two or more basic beams to be combined and/or a beam identifier of the basic beam to be divided.

### Supplementary Note 3

The communication method according to Supplementary Note 2, further including the steps of:
allocating, by the relay apparatus, a new beam identifier to a new beam obtained by the combining and/or to new beams obtained by the division; and
transmitting a notification including the new beam identifier from the control terminal to the network node.

### Supplementary Note 4

The communication method according to Supplementary Note 3, in which the notification includes information indicating a correspondence relationship between the beam identifiers of the combined two or more basic beams and the beam identifier of the new beam obtained by the combining.

### Supplementary Note 5

The communication method according to Supplementary Note 3 or 4, in which the notification includes information indicating a correspondence relationship between the beam identifier of the divided basic beam and a beam identifier of each new beam obtained by the division.

### Supplementary Note 6

The communication method according to any one of Supplementary Notes 1 to 5, further including transmitting capability information indicating a capability of the relay apparatus regarding the combining and/or the division from the control terminal to the network node.

### Supplementary Note 7

The communication method according to Supplementary Note 6, in which the capability information includes information indicating a combination of basic beams required to cover a coverage area of the relay apparatus.

### Supplementary Note 8

The communication method according to Supplementary Note 6 or 7, in which the capability information includes information indicating the number of possible divisions of each of the plurality of basic beams.

### Supplementary Note 9

The communication method according to any one of Supplementary Notes 6 to 8, in which the capability information includes a beam identifier of each preset divided beam for each of the plurality of basic beams.

### Supplementary Note 10

The communication method according to any one of Supplementary Notes 6 to 9, in which the capability information includes, for each of the plurality of basic beams, beam identifiers of other basic beams configured to be combined with the basic beam.

### Supplementary Note 11

A relay apparatus including:
a repeater configured to perform relay transmission of a radio signal between a network node and a user apparatus; and
a control terminal used to control the repeater,
in which the repeater forms a plurality of basic beams in different directions,
the control terminal receives, from the network node, a beam change request configured to designate two or more basic beams to be combined among the plurality of basic beams and/or a basic beam to be divided among the plurality of basic beams, and
the repeater performs, in response to receiving the beam change request, combining and/or division of the basic beams designated by the beam change request.

### Supplementary Note 12

A network node for communicating with a relay apparatus including a repeater configured to perform relay transmission of relaying a radio signal transmitted between the network node and a user apparatus, and a control terminal used to control the repeater, the network node including:
a transmitter configured to transmit, to the control terminal, a beam change request for designating two or more basic beams to be combined among a plurality of basic beams formed in different directions by the repeater and/or a basic beam to be divided among the plurality of basic beams.

### REFERENCE SIGNS

1: Mobile communication system
100: UE
200: gNB
210: Transmitter
220: Receiver
230: Controller
240: Backhaul communicator
300A: AMF
400: OAM server
500A: NCR apparatus
510A : NCR-Fwd
520A : NCR-MT
500B: RIS apparatus
510B: RIS-Fwd
520B: RIS-MT
511A: Wireless unit
511a: Antenna
511b: RF circuit
511c: Directivity controller
512A: NCR controller
512B: RIS controller
521: Receiver
522: Transmitter
523: Controller
530: Interface
550: Sensor

1. A communication method using a relay apparatus comprising a repeater configured to perform relay transmission of a radio signal between a network node and a user apparatus, and a control terminal used to control the repeater, the communication method comprising:
forming, by the repeater, a plurality of basic beams in different directions;
receiving, by the control terminal, a beam change request from the network node, the beam change request being configured to designate two or more basic beams to be combined among the plurality of basic beams and/or a basic beam to be divided among the plurality of basic beams; and
performing, by the repeater, combining and/or division of the basic beams designated by the beam change request in response to receiving the beam change request.

2. The communication method according to claim 1, wherein
a beam identifier configured to identify a basic beam is allocated to each of the plurality of basic beams; and
the beam change request comprises beam identifiers of the two or more basic beams to be combined and/or a beam identifier of the basic beam to be divided.

3. The communication method according to claim 2, further comprising:
allocating, by the relay apparatus, a new beam identifier to a new beam obtained by the combining and/or to new beams obtained by the division; and
transmitting a notification comprising the new beam identifier from the control terminal to the network node.

4. The communication method according to claim 3, wherein the notification comprises information indicating a correspondence relationship between the beam identifiers of the combined two or more basic beams and the beam identifier of the new beam obtained by the combining.

5. The communication method according to claim 3, wherein the notification comprises information indicating a correspondence relationship between the beam identifier of the divided basic beam and a beam identifier of each new beam obtained by the division.

6. The communication method according to claim 1, further comprising transmitting capability information indicating a capability of the relay apparatus regarding the combining and/or the division from the control terminal to the network node.

7. The communication method according to claim 6, wherein the capability information comprises information indicating a combination of basic beams required to cover a coverage area of the relay apparatus.

8. The communication method according to claim 6, wherein the capability information comprises information indicating the number of possible divisions of each of the plurality of basic beams.

9. The communication method according to claim 6, wherein the capability information comprises a beam identifier of each preset divided beam for each of the plurality of basic beams.

10. The communication method according to claim 6, wherein the capability information comprises, for each of the plurality of basic beams, beam identifiers of other basic beams configured to be combined with the basic beam.

11. A relay apparatus comprising:
a repeater configured to perform relay transmission of a radio signal between a network node and a user apparatus; and
a control terminal used to control the repeater,
wherein the repeater forms a plurality of basic beams in different directions,
the control terminal receives, from the network node, a beam change request configured to designate two or more basic beams to be combined among the plurality of basic beams and/or a basic beam to be divided among the plurality of basic beams, and
the repeater performs, in response to receiving the beam change request, combining and/or division of the basic beams designated by the beam change request.

12. A network node for communicating with a relay apparatus comprising a repeater configured to perform relay transmission of relaying a radio signal transmitted between the network node and a user apparatus, and a control terminal used to control the repeater, the network node comprising:
a transmitter configured to transmit, to the control terminal, a beam change request configured to designate two or more basic beams to be combined among a plurality of basic beams formed in different directions by the repeater and/or a basic beam to be divided among the plurality of basic beams.
